(19) United States
(12) Patent Application Publication
(10) Pub. No.: US 2006/0062722 A1
(43) Pub. Date: Mar. 23, 2006

(54) Method for preparing barium titanate

(75) Inventor: Ding-Chung Liou, Miao-Li City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Tonyong Applied Materials Technology Corp. Ltd., Taichung Hsien (TW)

(21) Appl. No.: 11/192,684

(22) Filed: Jul. 29, 2005

(30) Foreign Application Priority Data
Sep. 20, 2004 (TW) 093128374
Feb. 4, 2005 (TW) 094103658

(51) Int. Cl. C01G 23/00

(52) U.S. Cl. 423/598

(57) ABSTRACT

A method for preparing barium titanate powder, including preparing a pulp containing TiO(OH)₂₍ₛ₎, adding a solid Ba source into the pulp, filtering the pulp so as to form a cake of TiO(OH)₂₍ₛ₎ and the solid Ba source, and calcining the cake so as to form the barium titanate powder, is disclosed. A method for preparing barium titanate powder, including: preparing an aqueous TiOCl₂ solution by reacting an aqueous TiO(SO₄) solution with an aqueous barium chloride solution; adding an aqueous barium chloride solution and the aqueous TiOCl₂ solution into an aqueous oxalic acid solution so as to form a mixture with a precipitate of BaTiO(C₂O₄); filtering the mixture so as to form a cake of BaTiO(C₂O₄); and calcining the cake so as to form the barium titanate powder, is also disclosed.

### CROSS-REFERENCE TO RELATED APPLICATIONS

This application claims priority of Taiwanese application nos. 093128374 and 094103658, filed on Sep. 20, 2004 and Feb. 4, 2005, respectively.

### BACKGROUND OF THE INVENTION

1. Field of the Invention

This invention relates to a method for preparing barium titanate (BaTiO₃) powder, more particularly to a co-precipitation method for preparing barium titanate (BaTiO₃) powder through formation of metatitanic acid (TiO(OH)₂) or use of potassium titanium oxide oxalate (K₂TiO (C₂O₄)₂) or titanium oxide sulfate (TiO(SO₄)) as a starting material.

2. Description of the Related Art

Recently, peroviskite-type barium titanate (BaTiO₃) ceramic powders are used extensively in the manufacture of electronic devices, such as high-capacity capacitors and thermistors, due to their good dielectric characteristics. Conventional methods for preparing BaTiO₃ powder include:

(1) High Temperature Solid Phase Reaction

This method includes the steps of preparing a mixture containing barium carbonate (BaCO₃) powders and titanium dioxide (TiO₂) powders, thoroughly blending the mixture through repeated ball-milling, and calcining the ball-milledmixture so as to obtain barium titanate (BaTiO₃) powders. Since the powders produced by this method are required to be repeatedly ball-milled, the amount of impurities contained in the barium titanate powders tends to increase significantly. Besides, titanium to barium ratio and granularity of the powders are difficult to control. As such, undesired coagulation and unstable dielectric characteristics of the powders tend to occur.

(2) Co-Precipitation Method

U.S. Pat. Nos. 6,641,794 and 6,692,721 both disclose a method for manufacturing barium titanate powder by the steps of: reacting an aqueous barium chloride solution and an aqueous titanium chloride solution with an aqueous oxalic acid solution, there by precipitating barium titanyl oxalate (BaTiO(C₂O₄)₂₍ₛ₎); and thermally decomposing or calcining the barium titanyl oxalate so as to obtain the barium titanate powders. However, since titanium tetrachloride used for preparing the titanium chloride solution is a strong acid, transportation and storage of the same is relatively difficult. In addition, when water is added to titanium tetrachloride for preparing the titanium chloride solution, phosgene will be produced and can result in explosion. Therefore, use of titanium tetrachloride is not recommended.

U.S. Pat. No. 5,009,876 discloses a method of manufacturing barium titanate including adding an aqueous solution of barium chloride to an aqueous solution comprising a mixture of oxalic acid and titanium oxychloride so as to produce a precipitate of barium titanyl oxalate. The precipitate of barium titanyl oxalate is subsequently calcined so as to form barium titanate.

U.S. Pat. No. 5,783,165 discloses a method of producing barium titanate powder comprising adding barium carbonate to a solution which includes oxalic acid and titanium oxychloride, thereby precipitating barium titanyl oxalate, and calcining the barium titanyl oxalate so as to form the barium titanate powders.

(3) Water Heating

This method uses titanate as starting material, organic material as a chelating agent, and an alcohol as solvent, so as to prepare a homogenous gel. The gel is subsequently subjected to water heating reaction in a reactor under mild-temperature and high-pressure conditions, so as to form barium titanate powders that have the barium/ titanium ratio of about 1:1. However, since a large amount of the organic solvent is required for preparing the gel, environmental problems are easily encountered. In addition, the water heating reaction in the reactor should be controlled at a temperature ranging from 380° C. to 450° C. and a pressure higher than 200 atm. The equipment cost of this method is relatively high.

Therefore, there is still a need in the art to provide an economical method for preparing barium titanate powders.

### SUMMARY OF THE INVENTION

The object of the present invention is to provide a method for preparing barium titanate powder that is clear of the abovementioned drawbacks of the prior art.

According to one aspect of this invention, a method for preparing barium titanate (BaTiO₃) powder includes preparing a pulp containing metatitanic acid (TiO (OH)₂₍ₛ₎), adding a solid barium (Ba) source into the pulp, filtering the pulp so as to form a cake of metatitanic acid (TiO (OH)₂₍ₛ₎) and the solidbarium (Ba) source, and calcining the cake so as to form the barium titanate (BaTiO₃) powder.

According to another aspect of this invention, a method for preparing barium titanate (BaTiO₃) powder includes preparing an aqueous titanium oxychloride (TiOCl₂) solution by reacting an aqueous titanium oxide sulfate (TiO (SO₄)) solution with an aqueous barium chloride (BaCl₂) solution, adding an aqueous barium chloride (BaCl₂) solution and the aqueous titanium oxychloride (TiOCl₂) solution into an aqueous oxalic acid (H₂C₂O₄) solution so as to form a mixture with a precipitate of barium titanyl oxalate (BaTiO (C₂O₄)), filtering the mixture so as to form a cake of barium titanyl oxalate (BaTiO(C₂O₄)), and calcining the cake so as to form the barium titanate (BaTiO₃) powder.

### BRIEF DESCRIPTION OF THE DRAWINGS

Other features and advantages of the present invention will become apparent in the following detailed description of the preferred embodiments of the invention, with reference to the accompanying drawings. In the drawings:

FIG. 1 illustrates X-ray diffraction data of barium titanate powders made in accordance with the first preferred embodiment of a method for preparing barium titanate powders according to the present invention; and

FIG. 2 illustrates X-ray diffraction data of barium titanate powders made in accordance with the second preferred embodiment of a method for preparing barium titanate powders according to this invention.

### DETAILED DESCRIPTION OF THE PREFERRED EMBODIMENTS

The first preferred embodiment of the method for preparing barium titanate powders according to the present invention includes the steps of: preparing a pulp containing TiO(OH)₂₍ₛ₎; adding a solid Ba source into the pulp; filtering the pulp so as to form a cake of TiO (OH)₂₍ₛ₎ and the solid Ba source; and calcining the cake so as to form the barium titanate powders.

Preferably, the solid Ba source is selected from the group consisting of Ba(OH)₂₍ₛ₎ and BaCO₃₍ₛ₎. More preferably, the solid Ba source is Ba(OH)₂₍ₛ₎.

The pulp containing TiO(OH)₂₍ₛ₎ is prepared by reacting an aqueous TiOCl₂ solution with a weak base having OH group(s), such as sodium hydroxide or potassium hydroxide, in accordance with the following chemical equation:
TiOCl_{2(aq)}+2 X—OH→TiO(OH)₂₍ₛ₎↓+2 XCl_{(aq)},
wherein X represents Na or K. The weak base is optionally used in solution or solid forms. The pulp thus made has a pH ranging from 7 to 9.

Preferably, the aqueous TiOCl₂ solution is prepared by reacting an aqueous potassium titanium oxide oxalate (K₂TiO(C₂O₄)₂) solution with an aqueous barium chloride (BaCl₂) solution in accordance with the following chemical equation:
K₂TiO(C₂O₄)_{2(aq)}+2BaCl₂₍ₛ₎→TiOCl_{2(aq)}+2BaC₂O₄₍ₛ₎↓+2KCl_{(aq)}.
More preferably, the aqueous BaCl₂ solution contains 60 to 80 parts by weight of BaCl₂ per 100 parts by weight of K₂TiO(C₂O₄)₂ contained in the aqueous K₂TiO (C₂O₄)₂ solution.

More preferably, the weak base is potassium hydroxide (KOH) and is used in an amount of 10 to 20 parts by weight per 100 parts by weight of K₂TiO(C₂O₄)₂ contained in the aqueous K₂TiO(C₂O₄)₂ solution.

In addition, the Ba(OH)₂ is preferably used in an amount of 40 to 60 parts by weight per 100 parts by weight of K₂TiO(C₂O₄)₂ contained in the aqueous K₂TiO(C₂O₄)₂ solution.

Alternatively, the aqueous TiOCl₂ solution is prepared by reacting an aqueous titanium oxide sulfate (TiO(SO₄)) solution with an aqueous barium chloride (BaCl₂) solution in accordance with the following chemical equation:
TiO(SO₄)_{(aq)}+BaCl₂₍ₛ₎→TiOCl_{2(aq)}+BaSO₄₍ₛ₎↓.

Preferably, the BaCl₂ solution contains 60 to 80 parts by weight of BaCl₂ per 100 parts by weight of TiO(SO₄) used in the aqueous TiO(SO₄) solution.

Preferably, KOH is used in an amount of 10 to 20 parts by weight per 100 parts by weight of TiO(SO₄) contained in the aqueous TiO(SO₄) solution.

More preferably, Ba(OH)₂ is used in an amount of 40 to 60 parts by weight per 100 parts by weight of TiO(SO₄) contained in the aqueous TiO(SO₄) solution.

In the reactions of the aqueous K₂TiO(C₂O₄)₂ or TiO(SO₄) solution with the aqueous BaCl₂ solution, cation radical Ba²⁺ in the aqueous BaCl₂ solution reacts with anion radical C₂O₄²⁻ or SO₄²⁻ in the aqueous K₂TiO(C₂O₄)₂ or TiO(SO₄) solution so as to form BaC₂O₄ or BaSO₄ precipitate which will be subsequently removed through filtering operation.

In addition, the calcining operation of the cake of TiO(OH)₂₍ₛ₎ and the solid Ba source is preferably conducted at a temperature ranging from 700 to 950° C.

The second preferred embodiment of the method for preparing barium titanate powder according to the present invention includes the steps of: preparing an aqueous TiOCl₂ solution by reacting an aqueous TiO(SO₄) solution with an aqueous barium chloride solution; adding an aqueous barium chloride (BaCl₂) solution and the aqueous TiOCl₂ solution into an aqueous oxalic acid solution so as to form a mixture with a precipitate of BaTiO(C₂O₄); filtering the mixture so as to form a cake of BaTiO(C₂O₄) ; and calcining the cake so as to form the barium titanate powder.

Preferably, the aqueous BaCl₂ solution contains BaCl₂ in an amount of 100 to 130 parts by weight per 100 parts by weight of TiO (SO₄) contained in the aqueous TiO (SO₄) solution.

Preferably, the aqueous TiO(SO₄) solution has a concentration of 10 wt % to 30 wt %. The calcining operation of the cake of BaTiO(C₂O₄) is conducted at a temperature ranging from 700° C. to 1350° C.

Many other variations, modifications, and alternative embodiments may be made in the described methods, by those skilled in the art, without departing from the concept of the present invention. Accordingly, it should be clearly understood that the methods referred to in the foregoing description and following examples are illustrative only and are not intended to impose limitations upon the scope of this invention.

### EXAMPLES

Reactants:

1. Potassium titanium oxide oxalate (K₂TiO(C₂O₄)₂) commercially obtained from Ming-Young company, Taiwan;

2. Titanium oxide sulfate (TiO(SO₄)): commercially obtained from Ming-Young company, Taiwan;

3. Barium chloride (BaCl₂): commercially obtained from Ming-Young company, Taiwan;

4. Potassium hydroxide (KOH): commercially obtained from Ming-Young company, Taiwan; and

5. Barium hydroxide (Ba(OH)₂): commercially obtained from Ming-Young company, Taiwan.

### Example 1

An aqueous BaCl₂ solution containing 70 parts by weight of BaCl₂ was added to an aqueous K₂TiO(C₂O₄)₂ solution containing 100 parts by weight of K₂TiO(C₂O₄)₂, so as to form a first pulp primarily containing TiOCl₂ and BaC₂O₄ in accordance with the following chemical equation:
K₂TiO (C₂O₄)_{2(aq)}+2BaCl_{2(aq)}→TiOCl_{2(aq)}+2BaC₂O₄₍ₛ₎↓+2KCl_{(aq)}.
The first pulp was subsequently filtered to obtain a solution containing TiOCl₂ by removing BaC₂O₄ precipitate. 16 parts by weight of KOH was added to the solution containing TiOCl₂ to form a second pulp having a pH of 7 to 9 through reaction of the following chemical equation:
TiOCl_{2(aq)}+2KOH₍ₛ₎→TiO(OH)₂₍ₛ₎+2KCl_{(aq)}.
49 parts by weight of Ba(OH)₂₍ₛ₎ was added to the second pulp, and the second pulp was subsequently filtered to obtain a solid mixture containing TiO(OH)₂₍ₛ₎ and Ba(OH)₂₍ₛ₎.

Four samples of the solid mixture were made and were respectively calcined at 550° C., 700° C., 900° C., and 1100° C. so as to form barium titanate powders according to the following chemical equation:
TiO(OH)₂₍ₛ₎+Ba(OH)₂₍ₛ₎→BaTiO₃₍ₛ₎↓+2H₂O.

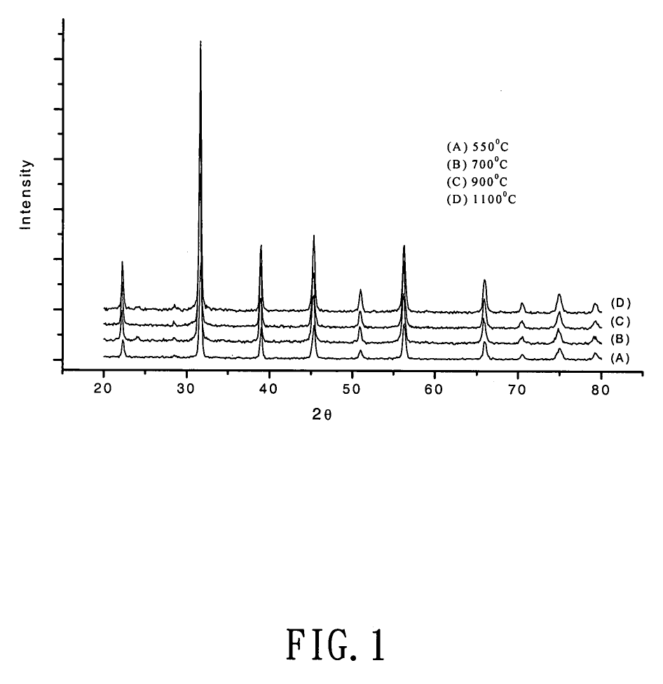

The barium titanate powders obtained from Example 1 were analyzed by X-ray diffraction spectrometer (XRD, Model No. RIGAKUD/MAZ+3COD-2988N) and the X-ray diffraction data are shown in FIG. 1. The peaks at 45° shown in FIG. 1 demonstrate that the barium titanate powders have a cubic structure.

### Example 2

An aqueous BaCl₂ solution containing 117 parts by weight of BaCl₂ was added to an aqueous TiO(SO₄) solution containing 100 parts by weight of TiO(SO₄), so as to form a pulp primarily containing TiOCl₂ and BaSO₄ in accordance with the following chemical equation:
TiO(SO₄)_{(aq)}+BaCl_{2(aq)}→TiOCl_{2(aq)}+BaSO₄₍ₛ₎↓.
The pulp was subsequently filtered to obtain a solution containing TiOCl₂ by removing BaSO₄ precipitate 110 parts by weight of BaCl₂ and 475 parts by weight of 20% oxalic acid were added in sequence to the filtered solution containing TiOCl₂ to undergo a reaction according to the following chemical equation:
TiOCl_{2(aq)}+BaCl₂+2H₂C₂O_{4(aq)}→BaTiO(C₂O₄)₂₍ₛ₎↓+4HCl_{(aq)}.
The reaction mixture was subsequently filtered to obtain a solid mixture containing BaTiO(C₂O₄)₂₍ₛ₎.

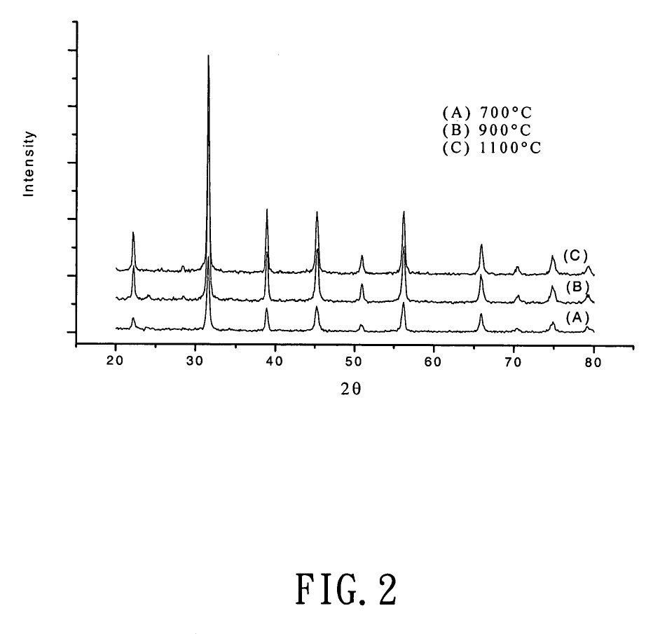

Three samples of the solid mixture were made and were respectively calcined at 700° C., 900° C., and 1100° C. so as to form barium titanate powders according to the following chemical equation:
BaTiO(C₂O₄)₂₍ₛ₎→BaTiO₃₍ₛ₎↓+4CO_{(g)}+O^{2(g)}.
The barium titanate powders obtained from Example 2 were analyzed by X-ray diffraction spectrometer (XRD, Model No. RIGAKUD/MAZ+3COD-2988N) and the X-ray diffraction data are shown in FIG. 2. The peaks at 45° shown in FIG. 2 demonstrate that the barium titanate powders have a cubic structure.

According to this invention, the barium titanate powders can be economically prepared by using (K₂TiO(C₂O₄)₂₋) or (TiO(SO₄) as a starting material. In addition, contrary to the conventional co-precipitation methods that are required to be carried out in an acidic condition, the method of this invention is capable of preparing barium titanate powders in a basic condition, and the barium titanate powders thus made have good purity, uniformity, and yield, and a cubic structure of high economic value.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

I claim:

1. A method for preparing barium titanate powder, comprising:
preparing a pulp containing TiO(OH)₂₍ₛ₎;
adding a solid Ba source into the pulp;
filtering the pulp so as to form a cake of TiO(OH)₂₍ₛ₎ and the solid Ba source; and
calcining the cake so as to form the barium titanate powder.

2. The method of claim 1, wherein the solid Ba source is selected from the group consisting of Ba(OH)₂₍ₛ₎ and BaCO₃₍ₛ₎.

3. The method of claim 2, wherein the solid Ba source is Ba (OH)₂₍ₛ₎.

4. The method of claim 3, wherein the pulp is prepared by reacting an aqueous TiOCl₂ solution with KOH, and has a pH ranging from 7 to 9.

5. The method of claim 4, wherein the aqueous TiOCl₂ solution is prepared by reacting an aqueous potassium titanium oxide oxalate solution with a barium chloride solution.

6. The method of claim 5, wherein the barium chloride solution contains 60 to 80 parts by weight of barium chloride per 100 parts by weight of potassium titanium oxide oxalate of the aqueous potassium titanium oxide oxalate solution.

7. The method of claim 6, wherein the KOH is in an amount of 10 to 20 parts by weight per 100 parts by weight of the potassium titanium oxide oxalate of the aqueous potassium titanium oxide oxalate solution.

8. The method of claim 5, wherein the Ba(OH)₂ is in an amount of 40 to 60 parts by weight per 100 parts by weight of potassium titanium oxide oxalate of the aqueous potassium titanium oxide oxalate solution.

9. The method of claim 4, wherein the aqueous TiOCl₂ solution is prepared by reacting an aqueous titanium oxide sulfate solution with a barium chloride solution.

10. The method of claim 9, wherein the barium chloride solution contains 60 to 80 parts by weight of barium chloride per 100 parts by weight of titanium oxide sulfate of the aqueous titanium oxide sulfate solution.

11. The method of claim 10, wherein the KOH is in an amount of 10 to 20 parts by weight per 100 parts by weight of titanium oxide sulfate of the aqueous titanium oxide sulfate solution.

12. The method of claim 9, wherein the Ba(OH)₂ is in an amount of 40 to 60 parts by weight per 100 parts by weight of titanium oxide sulfate of the aqueous titanium oxide sulfate solution.

13. The method of claim 1, wherein the calcining operation of the cake is conducted at a temperature ranging from 700 to 950° C.

14. A method for preparing barium titanate powder, comprising:
preparing an aqueous TiOCl₂ solution by reacting an aqueous TiO(SO₄) solution with an aqueous barium chloride solution;
adding an aqueous barium chloride solution and the aqueous TiOCl₂ solution into an aqueous oxalic acid solution so as to form a mixture with a precipitate of BaTiO (C₂O₄);
filtering the mixture so as to form a cake of BaTiO(C₂O₄); and
calcining the cake so as to form the barium titanate powder.

15. The method of claim 14, wherein the aqueous barium chloride solution contains barium chloride in an amount of 100 to 130 parts by weight per 100 parts by weight of TiO(SO₄) of the aqueous TiO(SO₄) solution.

16. The method of claim 15, wherein the aqueous TiO(SO₄) solution has a concentration of 10 wt % to 30 wt %.

17. The method of claim 16, wherein the calcining operation of the cake is conducted at a temperature ranging from 700° C. to 1350° C.
